(19) United States
(12) Patent Application Publication
(10) Pub. No.: US 2014/0075329 A1
(43) Pub. Date: Mar. 13, 2014

(54) METHOD AND DEVICE FOR TRANSMITTING INFORMATION RELATED TO EVENT

(71) Applicant: Samsung Electronics Co. Ltd., Suwon-si (KR)

(72) Inventors: Hyun-young KIM, Suwon-si (KR); Tae-hwan WI, Suwon-si (KR)

(73) Assignee: Samsung Electronics Co. Ltd., Suwon-si (KR)

(21) Appl. No.: 14/022,648

(22) Filed: Sep. 10, 2013

(30) Foreign Application Priority Data
Sep. 10, 2012 (KR) 10-2012-0099781

(51) Int. Cl. G06F 3/0484

(52) U.S. Cl. CPC G06F 3/04842
USPC 715/748

(57) ABSTRACT

A method and a device for transmitting information related to an event are provided. The method includes acquiring, by an event information acquirer, event information related to the event that occurs due to a connection of a device to a counterpart device through a Wireless Personal Area Network (WPAN), acquiring, by an additional information acquirer, additional information related to the event, displaying, by a service list display unit, a list of services corresponding to a type of the event based on the event information and the additional information, selecting at least one service from the displayed list of services based on a user input, and transmitting the event information and the additional information to a server that provides the selected service.

### CROSS-REFERENCE TO RELATED PATENT APPLICATION(S)

This application claims the benefit of a Korean patent application filed on Sep. 10, 2012 in the Korean Intellectual Property Office and assigned Serial No. 10-2012-0099781, the entire disclosure of which is hereby incorporated by reference.

### TECHNICAL FIELD

The present disclosure relates to a method and a device for transmitting information. More particularly, the present disclosure relates to a method and a device for transmitting information, which is related to an event occurring due to a short-range communication connection, through a certain service.

### BACKGROUND

As network technologies develop, a device may share various types of information with other devices and store the various types of information in a storage space on a network. In addition, as short-range communication technologies develop, the device may approach a counterpart device, and thus, various types of events occur. In addition, information related to the events may be easily acquired. Various services for sharing and posting information have appeared, and thus, a user may share and transmit various types of information by using the various services.

However, types of services that may be used by the user and types of data that may be transmitted through the services have become diversified. Therefore, it is difficult for the user to effectively select a desired service and effectively edit information that is to be transmitted.

Accordingly, there is a need for a method and a device for effectively selecting a service, effectively editing information, and transmitting the edited information through the selected service in order to transmit and store information related to an event through a certain service.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and a device for transmitting event information and additional information acquired from an occurrence of an event by using a certain service.

Another aspect of the present disclosure is to provide a method and a device for effectively selecting a service through which event information and additional information are to be transmitted and selecting information which is to be transmitted based on a service use history and an information transmission history.

Another aspect of the present disclosure is to provide a method and a device for effectively editing and transmitting event information and additional information.

In accordance with an aspect of the present disclosure, a method of transmitting information related to an event is provided. The method includes acquiring, by an event information acquirer, event information related to the event that occurs due to a connection of a device to a counterpart device through a Wireless Personal Area Network (WPAN), acquiring, by an event information acquirer, additional information related to the event, displaying, by a service list display unit, a list of services corresponding to a type of the event based on the event information and the additional information, selecting at least one service from the displayed list of services based on a user input, and transmitting the event information and the additional information to a server that provides the selected service.

The method may further include storing a use history of the selected service. The displaying of the list of services may include recommending the list of services to be displayed based on the event information, the additional information, and the service use history.

The method may further include providing an edit window for editing the event information and the additional information, and editing the event information and the additional information based on a user input performed through the edit window. The edited event information and the edited additional information may be transmitted to the server that provides the selected service.

The method may further include storing transmission history of the event information and the additional information according to the selected service, and recommending portions of the event information and the additional information based on the stored transmission history. The recommended event information and the recommended additional information may be transmitted to the server that provides the selected service.

The event information and the additional information may be converted into formats that are usable in the selected service, and the converted event information and the converted additional information may be transmitted to the server.

The event may include at least one of a payment event, a business card exchange event, a content exchange event, and a public transportation fare payment event, and the event information may include at least one of an article name, a shop name, a payment amount, business card information, a content type, a content title, and transportation information.

The additional information may include at least one of a date, a time, and a place when the event occurs, an image captured by the device within a preset time period from the time when the event occurs, an image captured by the device within a preset distance from the place where the event occurs, a voice recorded by the device within a preset time period from the time when the event occurs, and a voice recorded by the device within a preset distance from the place where the event occurs.

The service may include a Social Network Service (SNS), and one service may be selected from the list of services, an application corresponding to the selected service may be executed.

The selected service may include a diary providing service, and a position in which the event information and the additional information are to be recorded may be determined in a diary of a user provided by the service based on a date when the event occurs.

In accordance with another aspect of the present disclosure, a device is provided. The device includes an event information acquirer configured to acquire event information related to an event that occurs due to a connection of the device to a counterpart device through a WPAN, an additional information acquirer configured to acquire additional information related to the event, and a service list display unit configured to display a list of services corresponding to a type of the event based on the event information and the additional information. At least one service may be selected from the displayed list of services based on a user input, and the event information and the additional information may be transmitted to a server that provides the selected service.

The service list display unit may recommend a list of services to be displayed based on use history of the event information, the additional information, and the selected service.

The device may further include a transmission information determiner configured to determine information that is to be transmitted to the server among the event information and the additional information. The transmission information determiner may provide an edit window for editing the event information and the additional information, edit the event information and the additional information based on a user input performed through the edit window, and transmit the edited event information and the edited additional information to the server.

The transmission information determiner may recommend portions of the event information and the additional information based on transmission history of the event information and the additional information. The recommended event information and the recommended additional information may be transmitted to the server that provides the selected service.

The event information and the additional information may be converted into formats that are usable in the selected service, and the converted event information and the converted additional information may be transmitted to the server.

The event may include at least one of a payment event, a business card exchange event, a content exchange event, and a public transportation fare payment event, and the event information comprises at least one of an article name, a shop name, a payment amount, business card information, a content type, a content title, and transportation information.

The additional information may include at least one of a date, a time, and a place when the event occurs, an image captured by the device within a preset time period from the time when the event occurs, an image captured by the device within a preset distance from the place where the event occurs, a voice recorded by the device within a preset time period from the time when the event occurs, and a voice recorded by the device within a preset distance from the place where the event occurs.

The service may include an SNS, and as one service is selected from the list of services, an application corresponding to the selected service may be executed.

The service may include a diary providing service, and a position where the event information and the additional information are to be recorded is determined in a diary of a user provided by the selected service based on a date when the event occurs.

In accordance with another aspect of the present disclosure, a method of providing recommendation information for transmitting event information through a server is provided. The method includes receiving the event information related to an event that occurs due to a connection of a device to a counterpart device through a WPAN, from the device, receiving additional information related to the event from the device, recommending a service, which is used by the device to transmit the event information and the additional information, to the device based on the event information and the additional information, and recommending portions of the event information and the additional information to the device, so that the portions of the event information and the additional information are transmitted through the service. At least portions of the event information and the additional information may be transmitted from the device through a service selected from among the recommended services.

In accordance with another aspect of the present disclosure, a method of transmitting information related to an event is provided. The method includes acquiring event information related to the event that occurs due to a connection of a device to a counterpart device through a WPAN, acquiring additional information related to the event, recommending at least portions of the event information and the additional information as information that is to be transmitted through a diary service based on a transmission history of information transmitted through the diary service, and transmitting the recommended event information and the recommended additional information to a server that provides the diary service.

In accordance with another aspect of the present disclosure, a non-transitory computer-readable recording medium having recorded thereon a program, which, when executed by a computer, implements the method of transmitting information related to an event, is provided.

In accordance with another aspect of the present disclosure, a non-transitory computer-readable recording medium having recorded thereon a program, which, when executed by a computer, implements the method of providing recommendation information for transmitting event information through a server, is provided.

In accordance with another aspect of the present disclosure, a non-transitory computer-readable recording medium having recorded thereon a program, which, when executed by a computer, implements the method of transmitting information related to an event, is provided.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an information transmission system according to an embodiment of the present disclosure;

FIG. 2 is a flowchart illustrating a method of transmitting information related to an event that occurs due to a connection of a device to a counterpart device through a Wireless Personal Area Network (WPAN) according to an embodiment of the present disclosure;

FIG. 3 is a flowchart illustrating a method of displaying a list of services related to event information and additional information in a device according to an embodiment of the present disclosure;

FIG. 4 is a flowchart illustrating a method of determining information that is to be transmitted through a selected service, in a device, according to an embodiment of the present disclosure;

FIG. 5 is a flowchart illustrating a method of transmitting determined information from a device to a server according to an embodiment of the present disclosure;

FIG. 6 illustrates a table in which event information and additional information acquired by a device are recorded according to an embodiment of the present disclosure;

FIGS. 7A and 7B illustrate a list of services displayed on a device according to an embodiment of the present disclosure;

FIG. 8 illustrates an edit window display on a device according to an embodiment of the present disclosure;

FIG. 9 is a flowchart illustrating a method of transmitting event information and additional information from a device to a server that provides a diary service according to an embodiment of the present disclosure;

FIG. 10 illustrates a diary provided by a server to which event information and additional information are uploaded according to an embodiment of the present disclosure;

FIG. 11 is a flowchart illustrating a method of recommending a service related to event information and additional information and information that is to be transmitted through a service, in a server, according to an embodiment of the present disclosure;

FIG. 12 is a block diagram illustrating a device according to an embodiment of the present disclosure;

FIG. 13 is a block diagram illustrating a device according to an embodiment of the present disclosure; and

FIG. 14 is a block diagram illustrating a server according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In embodiments of the present disclosure, an event is used to achieve a certain object through a data exchange between a device and a counterpart device and occurs due to a short-range contact between the device and the counterpart device. For example, the event may include a payment event, a business card exchange event, a content exchange event, a public transportation fare payment event, a check-in event, and the like.

Event information used herein may be information that is transmitted and/or received between the device and the counterpart device in relation to an event that occurs. If the event is a payment event, the event information may include information about an article name, a shop name, and a payment amount. If the event is the business charge exchange event, the event information may include business card information. If the event is the content exchange event, the event information may include information about a title and a type of a content. If the event is the public transportation fare payment event, the event information may include information about a payment amount and a transportation type.

The check-in event refers to an event that is to record that a user has been in a certain position in a certain place. If the check-in event occurs due to an approach of the user to the counterpart device for generating the check-in event, the event information may include device information related to the occurrence of the check-in event.

In addition, the additional information used herein may be information that is additionally acquired by a device in relation to the event. The device may acquire the additional information from various types of sensors of the device and an external server. The additional information may include a date, a time, and a place when the event occurs, and an image captured in relation to the event but is not limited thereto.

A service used herein refers to a service through which the device may upload information into the server or another device. For example, the service may include a message transmission service, a Social Networking Service (SNS), a diary providing service, and the like, but is not limited thereto.

Various embodiments of the present disclosure will now be described with reference to the attached drawings.

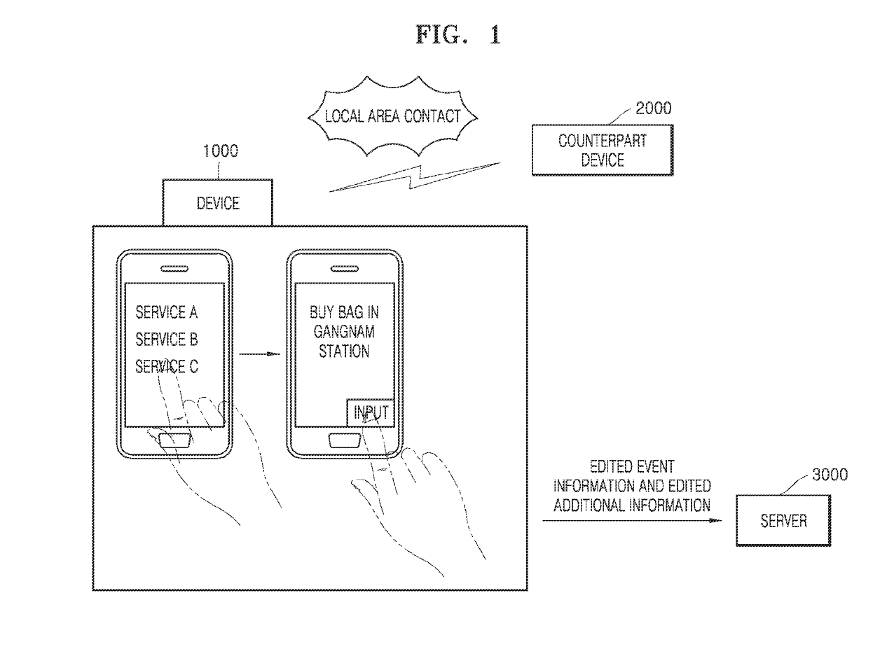

FIG. 1 illustrates an information transmission system according to an embodiment of the present disclosure.

Referring to FIG. 1, the information transmission system includes a device 1000, a counterpart device 2000, and a server 3000.

The device 1000 may approach the counterpart device 2000 so as to be connected to the counterpart device 2000 through a Wireless Personal Area Network (WPAN). The device 1000 may also acquire event information and additional information related to an event that occurs due to the connection of the device 1000 to the counterpart device 2000 through the WPAN. The device 1000 may recommend and select a service to upload the event information and the additional information to the server 3000 through the selected service. The device 1000 may also provide an edit window for editing the event information and the additional information and recommend portions of the event information and the additional information. The device 1000 may edit the recommended event information and additional information based on a user input through the edit window and upload the edited event information and additional information to the server 3000.

The device 1000 and the counterpart device 2000 may be smart phones, Personal Digital Assistants (PDAs), laptop computers, media players, Global Positioning System (GPS) devices, Point Of Service (POS) terminals, transportation fare payment terminals, or other mobile or immobile computing devices, but are not limited thereto.

The device 1000 and the server 3000 may be connected to each other through a network. The network may be realized as a wire network, such as a Local Area Network (LAN), a Wide Area Network (WAN), or a Value Added Network (VAN), or a wireless network, such as a mobile radio communication network, a Near Field Communication (NFC) network, or a satellite communication network. In addition, the network may be a comprehensive data communication network so that network components of FIG. 1 smoothly communicate with one another and may include a wired Internet, a wireless Internet, and a mobile wireless communication network.

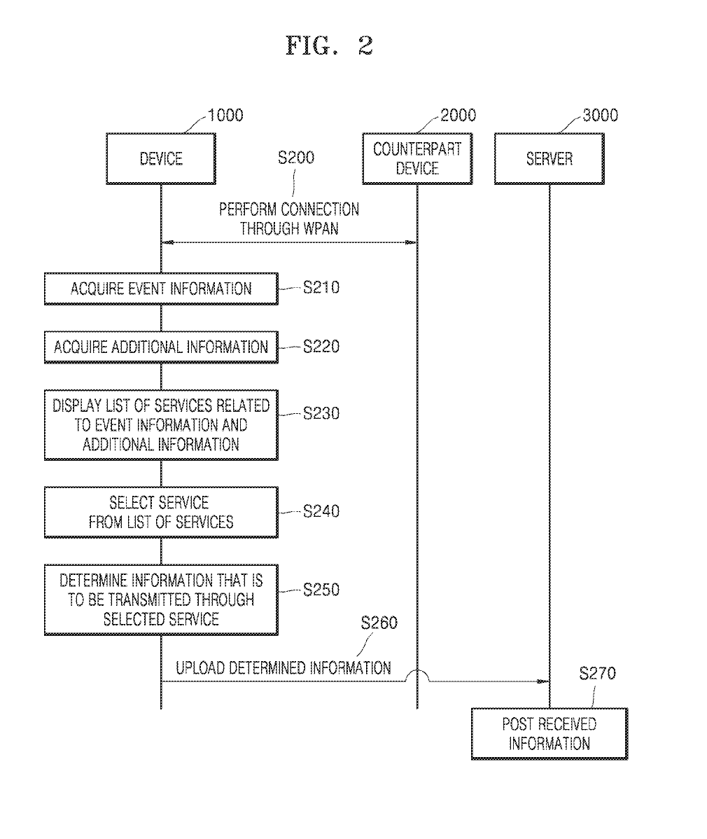

FIG. 2 is a flowchart illustrating a method of transmitting information related to an event that occurs due to a connection of a device to a counterpart device through a WPAN according to an embodiment of the present disclosure.

Referring to FIG. 2, in operation 5200, the device 1000 performs communication with the counterpart device 2000 through a WPAN. The device 1000 may approach the counterpart device 2000 within a range to be connected to the counterpart device 2000 through the WPAN. The WPAN may include an NFC, a Zigbee communication, a Radio Frequency Identification (RFID) communication, an Ultra Wide Band (UWB) communication, and Bluetooth communication, but is not limited thereto.

In operation 5210, the device 1000 acquires event information related to the event that has occurred through the WPAN. An event may occur due to the connection between the device 1000 and the counterpart device 2000 through the WPAN. The event may include a payment event, a business card exchange event, a content exchange event, a public transportation fare payment event, a check-in event, and the like, but is not limited thereto.

As the event occurs, the device 1000 may transmit and receive the event information with the counterpart device 2000 to acquire the event information. The event information may be information that is transmitted and received between the device 1000 and the counterpart device 2000 in relation to the event. However, the present disclosure is not limited thereto, and the device 1000 may acquire the event information through an additional server (not shown).

If the event is the payment event, the counterpart device 2000 may be a POS terminal. A user may let the device 1000 approach the counterpart device 2000 to pay for a certain article in order to transmit and receive information for the payment with the counterpart device 2000. The device 1000 may acquire information about an article name, a shop name, a shop address, a shop phone number, a unit price, the number of articles, card information, and a payment amount as the event information. However, the preset disclosure is not limited thereto, and thus, the device 1000 may acquire the event information through an additional payment server (not shown).

If the event is the business card exchange event, the device 1000 and the counterpart device 2000 may be mobile terminals. In addition, the device 1000 may approach the counterpart device 2000 to transmit and receive business card information stored in the device 1000 and business card information stored in the counterpart device 2000 with the counterpart device 2000. The device 1000 may acquire the transmitted and received business card information as the event information. The business card information may include a name, a contact number, and a photo.

If the event is the content exchange event, the device 1000 may transmit and receive contents stored in the device 1000 and contents stored in the counterpart device 2000 with the counterpart device 2000. In this case, the device 1000 and the counterpart device 2000 may transmit and receive a link address for downloading contents with the counterpart device 2000. The device 1000 may acquire information about the transmitted and received contents, the link address, titles of the contents, and types of contents as the event information. If the device 1000 transmits the link address for downloading contents, the device 1000 may acquire event information related to exchanges of the contents through a content providing server (not shown), but is not limited thereto.

If the event is the public transportation fare payment event, the counterpart device 2000 may be a transportation fare payment terminal. The transportation fare payment terminal may be a payment terminal used to pay a transportation fare and may be positioned in a place, such as a bus, a taxi, a subway station, a train station, or the like. The device 1000 may acquire information about the transportation fare, a station name, a stop name, and a transportation type as the event information.

If the event is the check-in event, the user may approach the counterpart device 2000 for generating the check-in event to acquire device information related to the occurrence of the check-in event as the event information.

In operation S220, the device 1000 acquires additional information related to the event. The additional information may include an occurrence date, an occurrence time, and an occurrence place of the event, and an image captured related to the occurrence of the event, but is not limited thereto. The device 1000 may acquire the additional information related to the event from various types of sensors of the device 1000 and an external server (not shown). For example, the device 1000 may acquire position information of the device 1000 at preset time intervals by using a GPS sensor and an Access Point (AP). The device 1000 may acquire situation information around the device 1000 by using a sensor, such as a temperature sensor, a motion sensor, a gravity sensor, a light sensor of the device, or the like. The device 1000 may determine a time and a date when the event occurs and may acquire an image captured by and a voice recorded in the device within a certain time from the time when the event occurs.

If the event is the payment event, the device 1000 may acquire a payment position, a payment date, a payment time, a photo captured within a preset distance from the payment position, a photo captured within a preset time period from the payment time, a voice recorded within a preset distance from the payment position, and a voice recorded within a preset time period from the payment time, as the additional information.

If the event is the business card exchange event, the device 1000 may acquire a business charge exchange date, a business card exchange time, a business card exchange place, a photo captured within a preset distance from a business card exchange position, a photo captured within a preset time period from the business card exchange time, a voice recorded within a preset distance from the business card exchange position, and a voice recorded within a preset time period from the business card exchange time, as the additional information.

If the event is the content exchange event, the device 1000 may acquire information about a content exchange date, a content exchange position, a content genre, and a user's evaluation, as the additional information.

If the event is the public transportation fare payment event, the device 1000 may acquire a riding date, a riding time, a riding place, an alighting time, an alighting place, a moving path, a photo captured on the moving path, and a voice recorded on the moving path, as the additional information.

If the event is the check-in event, the device 1000 may acquire information about a check-in place, a check-in time, and a check-in date as the additional information.

In operation S230, the device 1000 displays a list of services related to the event information and the additional information. The services allow the device 1000 to upload information to a server or another device. For example, the services may include a message transmission service, an SNS, and a diary providing service, but are not limited thereto.

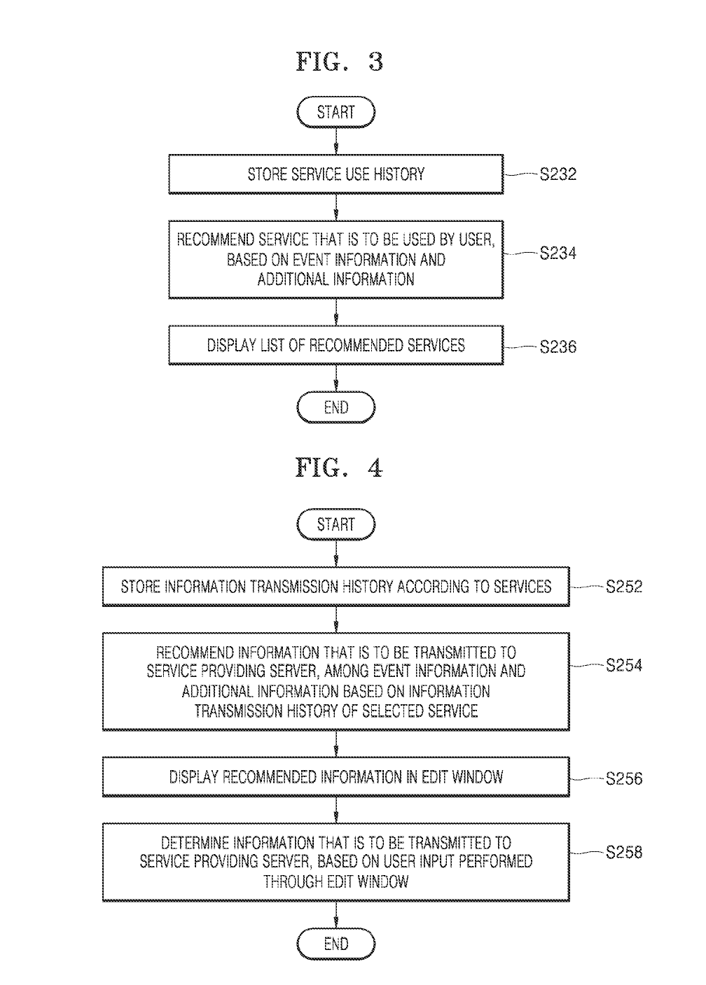

The device 1000 may display a list of services highly relevant to the acquired event information and additional information. The device 1000 may determine a usable SNS based on account information of the SNS stored in the device 1000, and recommend and display one of determined SNSs highly relevant to the acquired event information and additional information. The device 1000 may determine a usable diary providing service, and recommend and display one of determined diary providing services highly relevant to the acquired event information and additional information. A method of displaying a list of services in the device 1000 will be described below with reference to FIG. 3.

In operation S240, the device 1000 selects a service from the list of services. The device 1000 may select the service from the list of services based on a user input for the list of services.

In operation S250, the device 1000 determines information that is to be transmitted through the selected service. The device 1000 may determine at least portions of the acquired event information and service information as the information that is to be transmitted through the selected service. The device 1000 may determine one of the acquired event information and service information highly relevant to the selected service as the information to be transmitted.

The device 1000 may edit the acquired event information and service information and determine the edit information as the information that is to be transmitted through the selected service. The device 1000 may display a User Interface (UI) (for example, an edit window) for editing the acquired event information and service information and edit the acquired event information and service information based on a user input performed through the edit window.

A method of determining the information to be transmitted through the selected service in the device 1000 will be described below with reference to FIG. 4.

In operation S260, the device 1000 uploads the determined information to the server 3000 that provides the selected service. The device 1000 may execute an application corresponding to the selected service and input the determined information into the executed application. In this case, the device 1000 may convert the determined information into a format that may be used by the executed application and the server 3000 and input the converted information into the executed application. In addition, the executed application may upload the input information to the server 3000 that provides the selected service. In this case, the device 1000 may provide the server 3000 with user information, and the user information may include account information of a user for the selected service and an ID of the user.

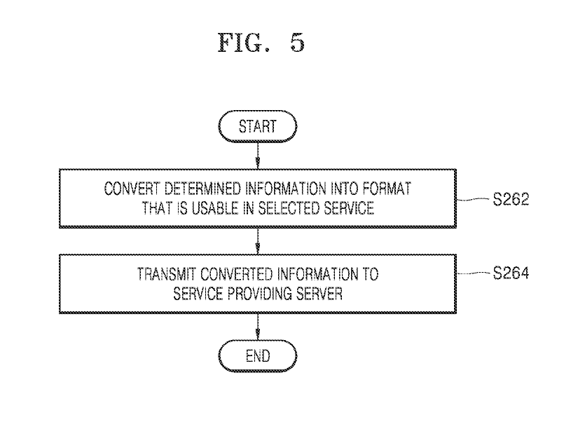

A method of uploading the determined information by the device 1000 will be described below with reference to FIG. 5.

In operation S270, the server 3000 posts information received from the device 1000. The server 3000 may post the information received from the device 1000 on a bulletin board corresponding to an account of the user of the device 1000. The server 3000 may store the information received from the device 1000 in a storage space corresponding to the account of the user of the device 1000. The server 3000 may transmit the information received from the device 1000 to a device of another user corresponding to the account of the user of the device 1000. For example, if the selected service is a diary providing service, the server 3000 may post the information received from the device 1000 in a certain position of a diary of the user of the device 1000. In this case, the server 3000 may determine a position where the received information is to be posted based on date information included in the received information.

FIG. 3 is a flowchart illustrating a method of displaying a list of services related to event information and additional information by a device according to an embodiment of the present disclosure.

Referring to FIG. 3, in operation S232, the device 1000 stores a service use history. The device 1000 may store acquisition history of event information and additional information according to each event that occurs through the approach of the device 1000 to the counterpart device 2000. The device 1000 may store a type of service selected for each event and a history of information transmitted through the selected service. Therefore, the device 1000 may accumulate and store information about which service has been selected and which information has been transmitted, according to a position, a time, and a date of the device 1000, a type of the counterpart device 2000, and a type of event.

In operation S234, the device 1000 recommends a service that is to be used by a user based on the event information and the additional information. The device 1000 may recommend the service that is to be used by the user based on a relation between the event occurring due to the approach of the device 1000 to the counterpart device 2000 and the service. The device 1000 may compare the acquired event information and additional information with the service use history and recommend a service through the event information and the additional information acquired from the event that have been transmitted a large number of times. The device 1000 may recommend a service that has been used more frequently in a current position of the device 1000 based on position information included in the acquired additional information. For example, if a payment event occurs, a payment amount is 5,000 won, a payment time is 14:00, a payment position is Gangnam station, and a frequently used service is Service A, the device 1000 may include the service A in a recommendation list of services.

The device 1000 may determine a service that may be used by the user and recommend a service among determined services. In this case, the device 1000 may determine the service that may be used by the user based on account information of the user.

In operation S236, the device 1000 displays a list of recommended services. The device 1000 may display the list of recommended services through an additional window, and the list of recommended services may include link information for executing an application related to the recommended services. The device 1000 may arrange the services included in the list of recommended services according to orders highly relevant to the event. In addition, the user may select a service included in the list of recommended services.

FIG. 4 is a flowchart illustrating a method of determining information that is to be transmitted through a selected service, by a device according to an embodiment of the present disclosure.

Referring to FIG. 4, in operation S252, the device 1000 stores an information transmission history according to each service. The device 1000 may accumulate and store information transmitted from the device 1000 according to each service. Therefore, the device 1000 may accumulate and store information about which information a user of the device 1000 has mainly transmitted through a certain service.

In operation S254, the device 1000 recommends information, which is to be transmitted to the server 3000 providing a service, among acquired event information and additional information based on the information transmission history of the selected service. For example, if Service A is selected, and information that is mainly transmitted through the Service A are a payment amount and a payment position, the device 1000 may recommend “5,000 won” and “Gangnam station” of the acquired event information and additional information, as information that is to be transmitted to the server 3000 providing the Service A.

In operation S256, the device 1000 displays the recommended information on an edit window. The device 1000 may generate an edit window so that the user edits the recommended information and may display the recommended information on the generated edit window.

In operation S258, the device 1000 may determine information that is to be transmitted to the server 3000 based on a user input performed through the edit window. The device 1000 may provide a UI for selecting the recommended information, and the user may select and determine certain information from the recommended information displayed on the edit window.

The device 1000 generates an additional edit window in operations S256 and S258, but is not limited thereto. The device 1000 may display recommended information in an execution window of an application of a selected service, and the user may select and edit the recommended information displayed on the execution window of the application.

FIG. 5 is a flowchart illustrating a method of transmitting determined information from a device to a server according to an embodiment of the present disclosure.

Referring to FIG. 5, in operation S262, the device 1000 converts determined information into a format that may be used through a selected service. The device 1000 may convert the determined information into a format that may be used by an application of the selected service and the server 3000 providing the selected service. The device 1000 may pre-collect and pre-store information about the server 3000 that provides the application of the selected service and the selected service and convert data of the certain information into a formation appropriate for the application and the server 3000.

In operation S264, the device 1000 transmits the converted information to the server 3000 that provides the service. The device 1000 may execute the application of the service selected from a list of services and insert the determined information into an execution window of the executed application. Here, the inserted information may be information that may be converted to be used by the executed application. In addition, the device 1000 may edit the information inserted into the execution window of the application based on a user input and transmit the edited information to the server 3000.

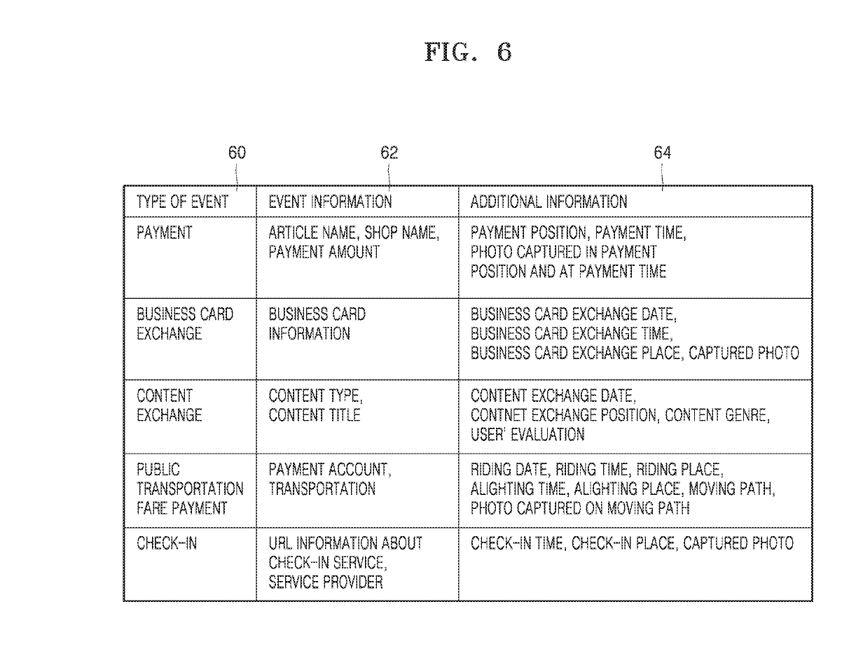

FIG. 6 illustrates a table in which event information and additional information acquired by a device are recorded according to an embodiment of the present disclosure.

Referring to FIG. 6, the table includes an event type field 60, an event information field 62, and an additional information field 64.

In the event type field 60, types of events are recorded, for example, a payment, a business card exchange, a content exchange, a public transportation fare payment, and a check-in may be recorded.

Event information acquired by the device 1000 is recorded in the event information field 62. The device 1000 may transmit and receive information to and from the counterpart device 2000 to acquire the event information. The event information may be information that may be transmitted and received between the device 1000 and the counterpart device 2000 in relation to an event that occurs. However, the present disclosure is not limited thereto, and the device 1000 may acquire the event information through an additional server (not shown). If a payment event occurs, information about an article name, a shop name, and a payment amount may be recorded in the event information field 62.

Additional information acquired by the device 1000 is recorded in the additional information field 64. The device 1000 may acquire the additional information related to the event via various types of sensors of the device 1000 and an external server (not shown). If the payment event, information about a payment position, a payment date, a payment time, and a photo captured in the payment position and at the payment time may be recorded in the additional information field 64.

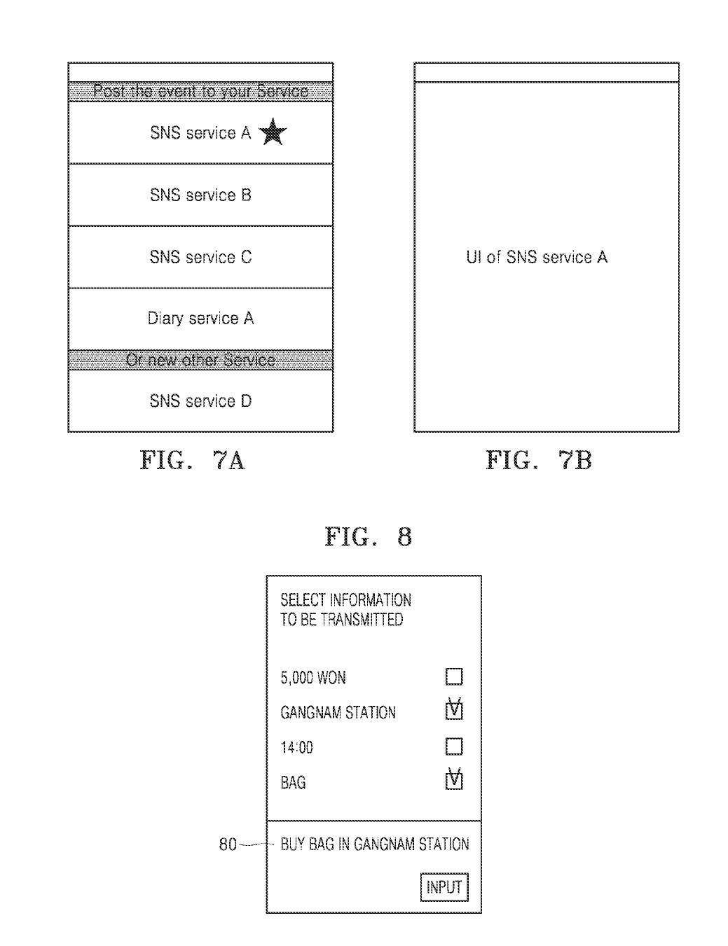

FIGS. 7A and 7B illustrate a list of services displayed in a device according to an embodiment of the present disclosure.

Referring to FIGS. 7A and 7B, an event occurs due to an approach of the device 1000 to the counterpart device 2000. Therefore, the device 1000 may acquire event information and additional information related to the event. In addition, the device 1000 may display a list of services as shown in FIG. 7A on a screen of the device 1000 to select a service through which the acquired event information and additional information are to be transmitted.

If SNS service A is selected from the list of the services, a UI of the SNS service A may be displayed on the screen of the device 1000 as shown in FIG. 7B. The UI of the SNS service A may be an execution window of an application that provides the SNS service A, but is not limited thereto. Therefore, the UI of the SNS service A may be a window through which certain information is to be input and edited in the execution window of the application that provides the SNS service A.

FIG. 8 illustrates an edit window displayed in a device according to an embodiment of the present disclosure.

Referring to FIG. 8, event information and additional information recommended by the device 1000 may be displayed in the edit window for editing the event information and the additional information. If a payment event occurs, among the acquired event information and additional information, information about a payment amount, a payment position, a payment time, and an article name, such as “5,000 won”, “Gangnam station”, “14:00”, and “bag”, may be recommended and displayed.

If a user selects “Gangnam station” and “bag”, the device 1000 may display a sentence 80 “Buy a bag in Gangnam station”. In addition, the user may edit the sentence 80 displayed in the edit window, and the edited sentence 80 may be inserted into an execution window of an application for providing a service selected by the device 1000.

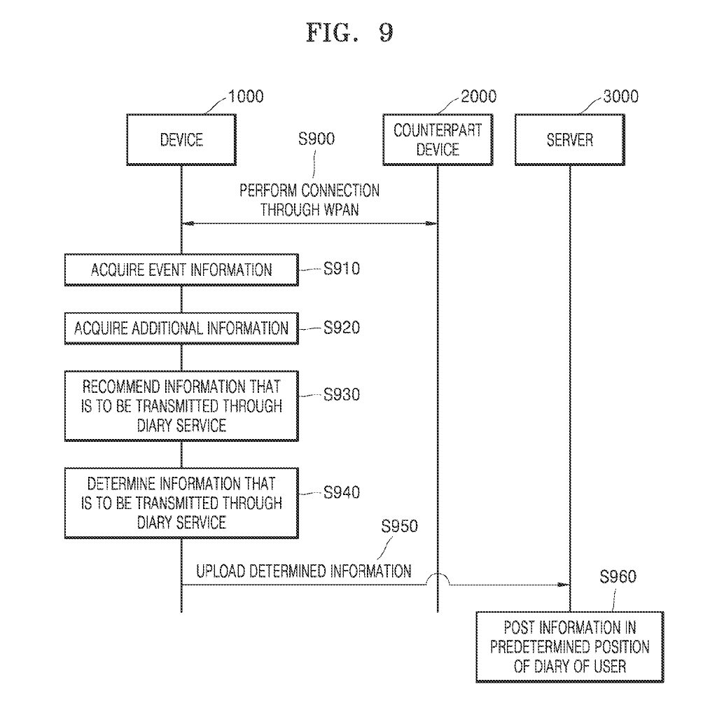

FIG. 9 is a flowchart illustrating a method of transmitting event information and additional information from a device to a server that provides a diary service according to an embodiment of the present disclosure.

Referring to FIG. 9, at operations S900 through S920 respectively correspond to operations S200 through S220, and thus, their descriptions will be omitted.

In operation S930, the device 1000 recommends information that is to be transmitted through a diary service. The device 1000 may store an information transmission history of the diary service and recommend the information to be transmitted based on the stored information transmission history. For example, if a payment event occurs, and information about a paid article, a payment amount, a payment time, and a payment place is mainly transmitted through the diary service, the device 1000 may recommend “bag”, “5,000 won”, “14:00”, and “Gangnam station” among the event information and the additional information acquired through the occurrence of the event, as the information to be transmitted.

In operation S940, the device 1000 determines the information to be transmitted through the diary service. The device 1000 may display and edit information for selecting and editing a portion of the recommended information on a screen of the device 1000 and determine the information to be transmitted based on a user input performed through the edit window. For example, a user may select “bag”, “5,000 won”, and “Gangnam station” from “bag”, “5,000 won”, “14:00”, and “Gangnam station” that are recommended and edit a sentence to be transmitted like “Buy a 5,000 won bag in Gangnam station.”

In operation S950, the device 1000 transmits the determined information to the server 3000 that provides the diary service. The device 1000 may transmit the determined information to the server 3000 in operation S940. The device 1000 may transmit date information and time information along with the determined information so that the server 3000 records the transmitted information in a certain position of a diary.

The device 1000 may execute a certain application for the diary service and transmit the determined information through the executed application. The device 1000 may convert the determined information into a format that may be used by the server 3000 providing the diary service and the application and transmit the converted information to the server 3000.

In operation S960, the server 3000 posts the received information in a certain position of the diary of the user. The server 3000 may determine a position of the diary where the determined information is to be displayed based on information about a date and a time when the information is received from the device 1000. The server 3000 may also post the determined information in the determined position of the diary.

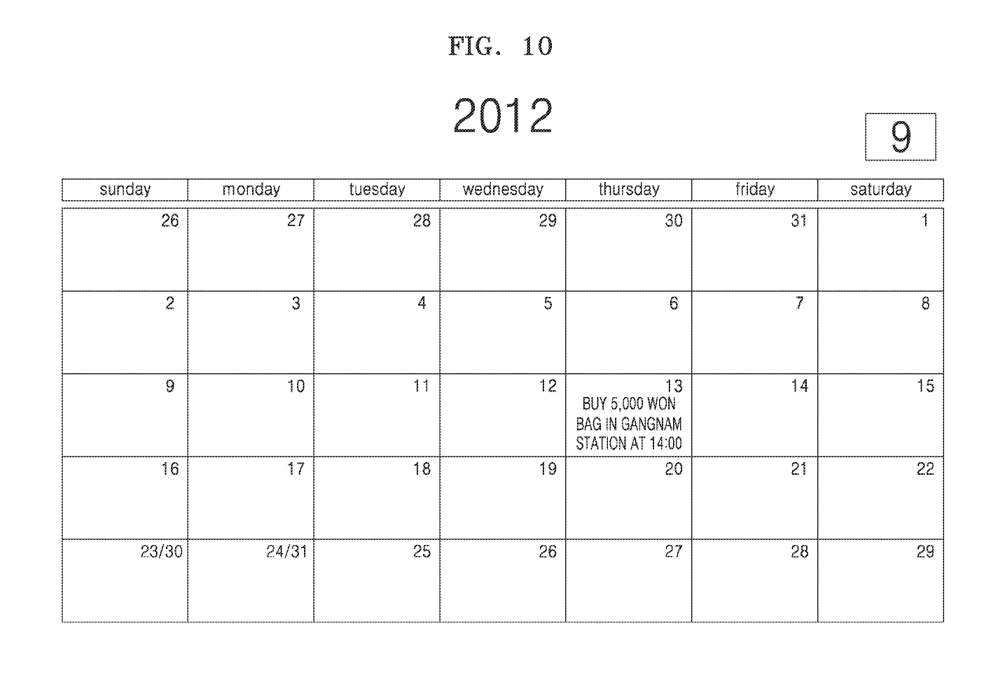

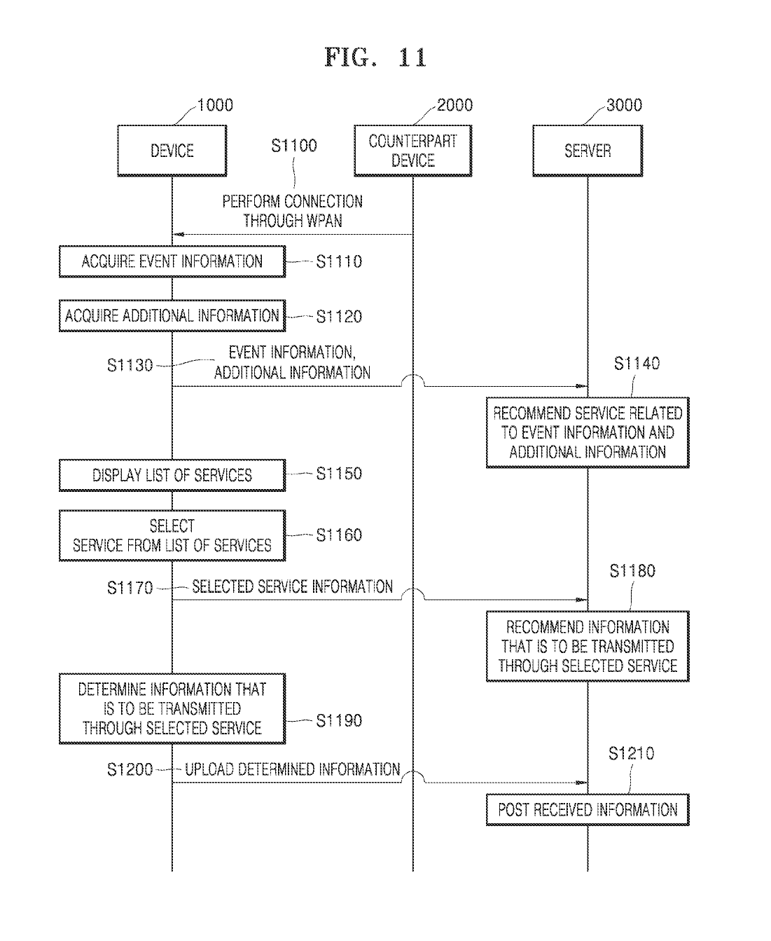

FIG. 10 illustrates a diary provided by a server in which event information and additional information are uploaded according to an embodiment of the present disclosure.

Referring to FIG. 10, the server 3000 may receive event information and additional information determined by the device 1000 and record the received information in a diary of a user of the device 1000. The server 3000 may receive information about a date when an event occurs, from the device 1000 and determine a position of the diary where the information is to be recorded based on the date information. The server 3000 may record received event information and additional information in the determined position. For example, the server 3000 may record a sentence “Buy a 5,000 won bag at 14:00 in Gangnam station.” in a field corresponding to 9/13 of the diary.

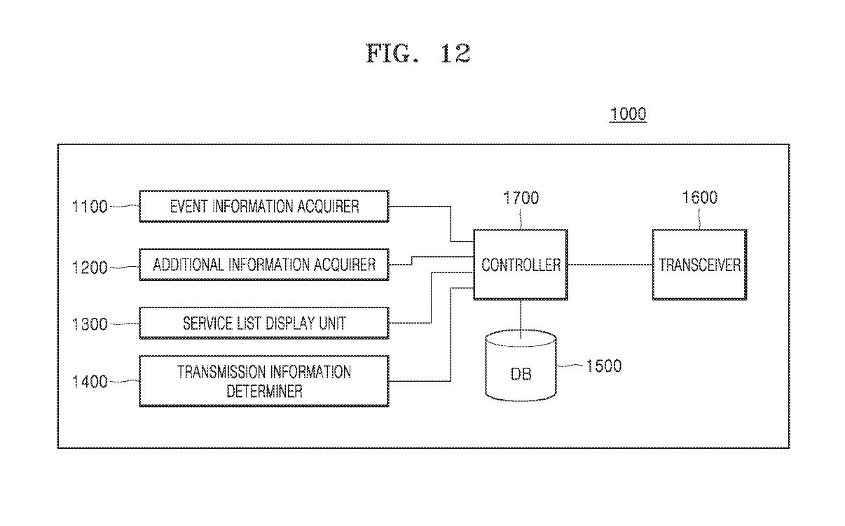

FIG. 11 is a flowchart illustrating a method of recommending a service related to event information and additional information and information that is to be transmitted through the service, by a server according to an embodiment of the present disclosure.

Referring to FIG. 11, operations S1100 through S1120 respectively correspond to operations S200 through 220, and thus, their descriptions will be omitted here.

In operation S1130, the device 1000 transmits acquired event information and additional information to the server 3000. In operation S1140, the server 3000 recommends a service related to the event information and the additional information.

The server 3000 may recommend a list of services highly relevant to the event information and the additional information in operation S1140. The server 3000 may receive account information of an SNS of a user from the device 1000, determine an SNS, which may be used by the device 1000, based on the received account information, and recommend one of determined SNSs highly relevant to the acquired event information and additional information to the device 1000. The server 3000 may determine a diary providing service that may be used by the device 1000 and recommend one of determined diary providing services highly relevant to the acquired event information and additional information. The server 3000 may store and update a service use history of the device 1000 to recommend a service.

In operation S1150, the device 1000 displays a list of services recommended by the server 3000. In operation S1160, the device 1000 selects a certain service based on a user input.

In operation S1170, the device 1000 transmits service information about the selected service to the server 3000. The service information may include an identification value of the service, but is not limited thereto.

In operation S1180, the server 3000 recommends information that is to be transmitted by the device 1000 through the selected service. The server 3000 may recommend the device 1000 information highly relevant to the selected service among the event information and the additional information acquired by the device 1000.

In operation S1190, the device 1000 determines information that is to be transmitted through the selected service. The device 1000 may edit the information recommended by the server 3000 and determine the edited information as the information that is to be transmitted through the selected service. The device 1000 may display a UI for editing the recommended event information and additional information and edit the acquired event information and additional information based on a user input performed through an edit window.

In operation S1200, the device 1000 uploads the determined information to the server 3000 that provides the selected service. The device 1000 may execute an application of the selected service and input the determined information into the executed application. In this case, the device 1000 may convert the determined information into a format that may be used by the executed application and the server 3000 and input the converted information into the executed application. The executed application may upload information input into the server 3000 that provides the selected service. In this case, the device 1000 may provide user information to the server 3000, and the user information may include account information of the user for the selected service and an IDentification (ID) of the user. If the server 3000 does not provide the selected service, the device 1000 may provide the determined information to another server (not shown) in operation S1200.

In operation S1210, the server 3000 posts the information received from the device 1000. The server 3000 may post the information received from the device 1000 on a bulletin board corresponding to an account of the user of the device 1000. The server 3000 may also store the information received from the device 1000 in a storage space corresponding to the account of the user of the device 1000. The server 3000 may transmit the information received from the device 1000 to a device of another user corresponding to the account of the user of the device 1000. For example, if the selected service is a diary providing service, the server 3000 may post the information received from the device 1000 in a certain position of a diary of the user of the device 1000. In this case, the server 3000 may determine a position in which the received information is to be posted based on date information included in the received information.

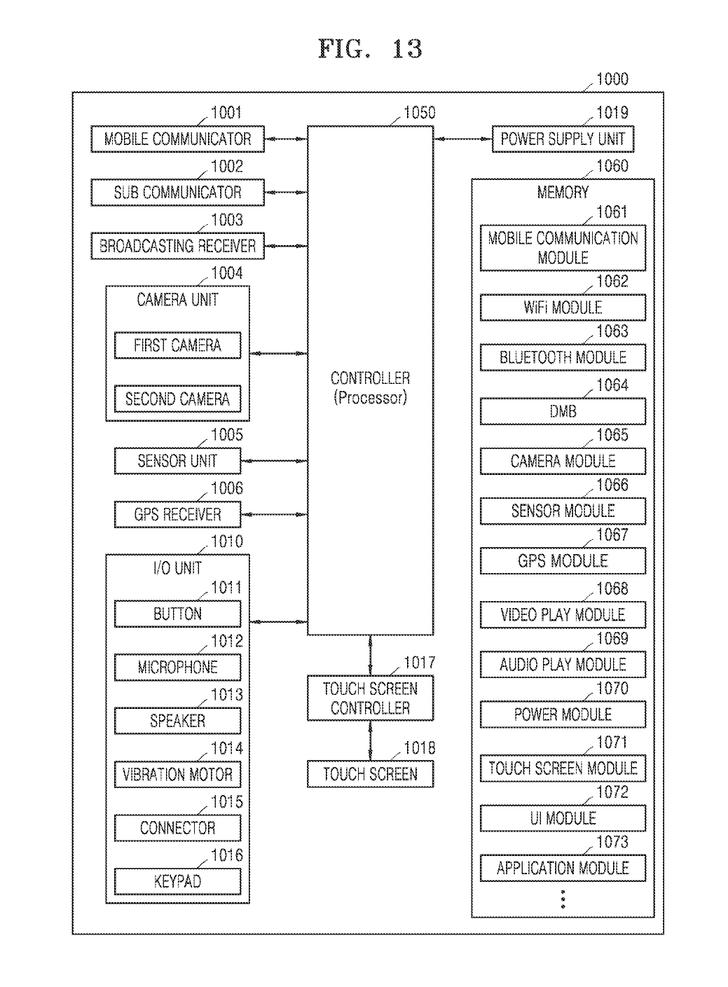

FIG. 12 is a block diagram of a device according to an embodiment of the present disclosure.

Referring to FIG. 12, the device 1000 includes an event information acquirer 1100, an additional information acquirer 1200, a service list display unit 1300, a transmission information determiner 1400, a DataBase (DB) 1500, a transceiver 1600, and a controller 1700.

The event information acquirer 1100 acquires event information related to an event that occurs due to a connection between the device 1000 and the counterpart device 2000 through a WPAN. Here, when the device 1000 is connected to the counterpart device 2000 through the WPAN, a certain event may occur. The event may include a payment event, a business card exchange event, a content exchange event, a public transportation fare payment event, and a check-in event, but is not limited thereto.

As the event occurs, the event information acquirer 1100 may transmit and receive the event information with the counterpart device 2000 to acquire the event information. The event information may be information that is transmitted and received between the device 1000 and the counterpart device 2000 in relation to the event, but is not limited thereto. Therefore, the event information acquirer 1100 may acquire the event information through an additional server (not shown).

The additional information acquirer 1200 acquires the additional information related to the event. The additional information may include a date, a time, and a place when the event occurs, and an image captured in relation to the occurrence of the event, but is not limited thereto. The additional information acquirer 1200 may acquire the additional information related to the event from various types of sensors of the device 1000 and an external server (not shown). For example, the additional information acquirer 1200 may acquire position information of the device 1000 at preset time intervals by using a GPS sensor and an AP. The additional information acquirer 1200 may acquire situation information around the device 1000 by using a sensor, such as a temperature sensor, a motion sensor, a gravity sensor, a light sensor, or the like, of the device 1000. The additional information acquirer 1200 may determine the time and date when the event occurs and acquire an image captured and a voice recorded in the device 1000 within a certain time period from the time when the event occurs.

The service list display unit 1300 displays a service list related to the event information and the additional information. A service is used by the device 1000 to upload certain information to a server or another device. For example, the service may include a message transmission service, an SNS, or a diary providing service, but is not limited thereto.

The service list display unit 1300 may display a list of services highly relevant to the event information and the additional information. The service list display unit 1300 may determine an SNS that may be used by the device 1000 based on account information of an SNS stored in the device 1000, and recommend and display one of determined SNSs highly relevant to the event information and the additional information. The service list display unit 1300 may determine a diary providing service that may be used by the device 1000, and recommend and display one of determined diary providing services highly relevant to the event information and the additional information.

The service list display unit 1300 may provide the event information and the additional information to the server 3000 and display a service recommendation list received from the server 3000 on a screen.

The transmission information determiner 1400 determines information that is to be transmitted through a selected service. The transmission information determiner 1400 may determine at least a portion of acquired event information and service information as the information that is to be transmitted through the selected service. The transmission information determiner 1400 may determine information of the acquired event information and service information highly relevant to the selected service as the information to be transmitted.

The transmission information determiner 1400 may edit the acquired event information and service information and determine the edited information as the information that is to be transmitted through the selected service. The transmission information determiner 1400 may display a UI (for example, an edit window) for editing the acquired event information and service information and edit the acquired event information and service information based on a user input performed through the edit window.

The transmission information determiner 1400 may display information recommended by the server 3000 in the edit window and determine information that is to be provided to the server 3000 or another server (not shown) based on a user input performed through the edit window.

The DB 1500 acquires the event information and the additional information related to the event that occurs due to an approach of the device 1000 to the counterpart device 2000, selects a service through which the acquired information is to be transmitted, and stores various types of information used for determining the information to be transmitted.

The transceiver 1600 transmits the information determined by the transmission information determiner 1400 to the server 3000. The transceiver 1600 acquires the event information and the additional information related to the event that occurs due to the approach of the device 1000 to the counterpart device 2000, selects a service through which the acquired information is to be transmitted, and transmits and receives various types of information used for determining the information to be transmitted, to and from the counterpart device 2000, the server 3000, and the other server.

The controller 1700 controls the event information acquirer 1100, the additional information acquirer 1200, the service list display unit 1300, the transmission information determiner 1400, the DB 1500, and the transceiver 1600 to acquire the event information and the additional information related to the event that occurs due to the approach of the device 1000 to the counterpart device 2000, selects the service through which the acquired information is to be transmitted, and determines the information to be transmitted.

Some or all of the event information acquirer 1100, the additional information acquirer 1200, the service list display unit 1300, and the transmission information determiner 1400 may be operated by a software module, but are not limited thereto. Some of the event information acquirer 1100, the additional information acquirer 1200, the service list display unit 1300, and the transmission information determiner 1400 may be operated by hardware.

At least some of the event information acquirer 1100, the additional information acquirer 1200, the service list display unit 1300, and the transmission information determiner 1400 may be included in the controller 1700. In addition, the event information acquirer 1100, the additional information acquirer 1200, the service list display unit 1300, the transmission information determiner 1400, and the controller 1700 may be operated by one processor, but are not limited thereto.

FIG. 13 is a block diagram of a device according to an embodiment of the present disclosure.

Referring to FIG. 13, a mobile communicator 1001 sets a call with a base station and performs data communication with the base station through a cellular network, such as a 3^{rd} Generation/4^{th} Generation (3G/4G) network. A sub communicator 1002 performs a function for a WPAN, such as Bluetooth, NFC, or the like. A broadcasting receiver 1003 receives a Digital Multimedia Broadcasting (DMB) signal.

A camera unit 1004 includes lenses and optical elements for capturing images or moving pictures.

A sensor unit 1005 may include a gravity sensor that detects a motion of the device 1000, an illumination sensor that detects brightness of light, a proximity sensor that detects proximity of a person, a motion sensor that detects a motion of the person, and the like.

A GPS receiver 1006 receives a GPS signal from a satellite. Various services may be provided to a user by using the GPS signal.

An Input/Output (I/O) unit 1010 provides an interface with an external device or a person and includes a button 1011, a microphone 1012, a speaker 1013, a vibration motor 1014, a connector 1015, and a keypad 1016.

A touch screen 1018 receives a touch input of a user. A touch screen controller 1017 transmits the touch input received through the touch screen 1018 to a controller 1050. A power supply unit 1019 is connected to a battery or an external power source to supply power needed for the device 1000.

The controller 1050 may execute programs stored in a memory 1060 to transmit at least a portion of event information and additional information through a certain service.

The programs stored in the memory 1060 may be classified into a plurality of modules according to their functions, i.e., may be classified into a mobile communication module 1061, a Wi-Fi module 1062, a Bluetooth module 1063, a DMB module 1064, a camera module 1065, a sensor module 1066, a GPS module 1067, a video play module 1068, an audio play module 1069, a power module 1070, a touch screen module 1071, a UI module 1072, an application module 1073, and the like.

Functions of the above-mentioned modules may be intuitively deduced from their names by those of ordinary skill in the art, and thus, the application module 1073 will be described herein. The application module 1073 acquires event information related to an event that occurs due to a connection between the device 1000 and the counterpart device 2000 through a WPAN. The application module 1073 may transmit and receive the event information with the counterpart device 2000 by using the sub communicator 1002. The event information may be information that is transmitted and received between the device 1000 and the counterpart device 2000. However, the present disclosure is not limited thereto, and the application module 1073 may acquire the event information from an additional server (not shown) by using at least one of the mobile communicator 1001 and the broadcasting receiver 1003.

The application module 1073 also acquires additional information related to the event. The additional information may include a date, a time, and a place when the event occurs, and an image captured in relation to the occurrence of the event, but is not limited thereto. The application module 1073 may acquire the additional information related to the event from various types of sensors of the device 1000 and an external server (not shown).

The application module 1073 generates and displays a service list related to the event information and the additional information. The application module 1073 may display a list of services highly relevant to the event information and the additional information on a touch screen 1018. The application module 1073 may determine an SNS that may be used by the device 1000 based on account information of an SNS stored in the device 1000, and recommend and display one of determined SNSs highly relevant to the event information and the additional information. The application module 1073 may determine a diary providing service that may be used by the device 1000, and recommend and display one of diary providing services highly relevant to the event information and the additional information. The application module 1073 may provide the event information and the additional information to the server 3000 and display a service recommendation list received from the server 3000 on the touch screen 1018.

The application module 1073 determines information that is to be transmitted through a service from the service list. The application module 1073 may determine at least a portion of the event information and the additional information as the information that is to be transmitted through the service selected from the service list. The application module 1073 may determine information of the event information and service information highly relevant to the selected service as the information to be transmitted.

The application module 1073 may edit the event information and the service information and determine the edited information as the information that is to be transmitted through the selected service. The application module 1073 may display a UI (for example, an edit window) for editing the event information and the service information and edit the event information and the service information based on a user input performed through the edit window.

The application module 1073 may display information recommended by the server 3000 in the edit window and determine information that is to be transmitted to the server 3000 or another server (not shown) based on a user input performed through the edit window.

The application module 1073 may transmit the determined information to the server 3000 by using the sub communicator 1002.

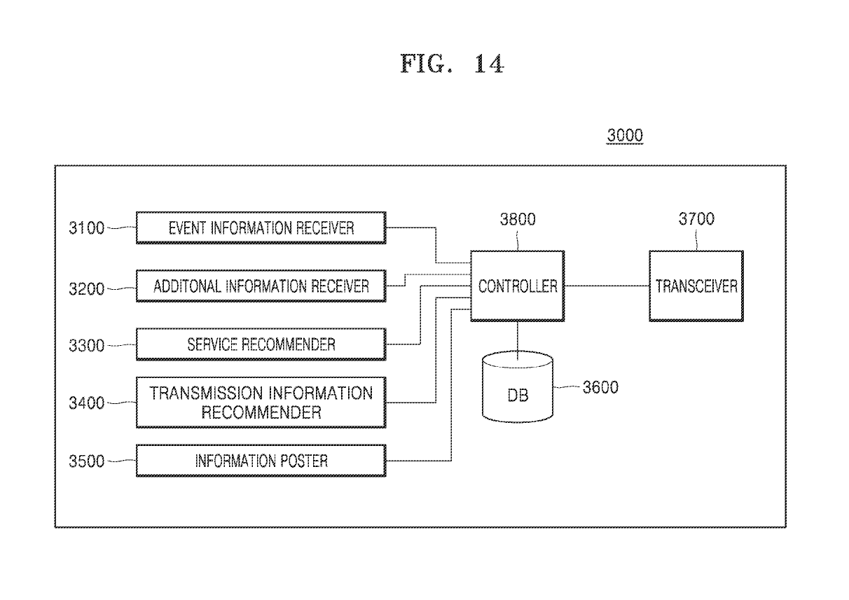

FIG. 14 is a block diagram of a server according to an embodiment of the present disclosure.

Referring to FIG. 14, the server 3000 includes an event information receiver 3100, an additional information receiver 3200, a service recommender 3300, a transmission information recommender 3400, an information poster 3500, a DB 3600, a transceiver 3700, and a controller 3800.

The event information receiver 3100 receives event information from the device 1000. An event may occur due to a connection between the device 1000 and the counterpart device 2000 through a WPAN, and the event information receiver 3100 may receive event information acquired by the device 1000 from the device 1000. The event may include a payment event, a business card exchange event, a content exchange event, a public transportation fare payment event, and a check-in event, but is not limited thereto.

The additional information receiver 3200 may receive additional information related to the event from the device 1000. The device 1000 may acquire the additional information related to the event via various types of sensors of the device 1000 and an external server (not shown), and the additional information server 3200 may receive the additional information acquired by the device 1000 from the device 1000. The additional information may include a date, a time, and a place when the event occurs, and an image captured in relation to the occurrence of the event, but is not limited thereto.

The service recommender 3300 may recommend a list of services highly relevant to the event information and the additional information to the device 1000. The service recommender 3300 may receive account information of an SNS of a user from the device 1000, determine an SNS that may be used by the device 1000, based on the received account information, and recommend one of determined SNSs highly relevant to the event information and additional information to the device 1000. The service recommender 3300 may determine a diary providing service that may be used by the device 1000 and recommend one of determined diary providing services highly relevant to the event information and the additional information. The service recommender 3300 may store and update a service use history of the device 1000 to recommend a service.

The transmission information recommender 3400 may recommend to the device 1000 information highly relevant to a service selected by the device 1000 among the event information and the additional information acquired by the device 1000.

The information poster 3500 may receive the edited event information and additional information from the device 1000 and post received information in a post space related to a service selected by the device 1000. The information poster 3500 may post information received from the device 1000 on a bulletin board corresponding to an account of the user of the device 1000. The information poster 3500 may store the information received from the device 1000 in a storage space corresponding to the account of the user of the device 1000. The information poster 3500 may transmit the information received from the device 1000 to a device of another user corresponding to the account of the user of the device 1000. For example, if the selected service is a diary providing service, the information poster 3500 may post the information received from the device 1000 in a certain position of a diary of the user of the device 1000. In this case, the information poster 3500 may determine a position in which the received information is to be posted based on date information included in the received information.

The DB 3600 stores various types of information through which the server 3000 recommends a certain service to the device 1000 and recommends information that is to be transmitted by the device through the service selected by the device 1000.

The transceiver 3700 may transmit and receive the various types of information which the server 3000 recommends through the certain service to the device 1000 and recommends information that is to be transmitted by the device 1000 through the service selected by the device 1000, to and from the device 1000, the counterpart device 2000, and the other server.

The controller 3800 controls the event information receiver 3100, the additional information receiver 3200, the service recommender 3300, the transmission information recommender 3400, the information poster 3500, the DB 3600, and the transceiver 3700 to allow the server 3000 to recommend the certain service to the device 1000 and to recommend information that is to be recommended by the device 1000 through the service selected by the device 1000.

Some or all of the event information receiver 3100, the additional information receiver 3200, the service recommender 3300, the transmission information recommender 3400, and the information poster 3500 may be operated by a software module, but are not limited thereto. Some of the event information receiver 3100, the additional information receiver 3200, the service recommender 3300, the transmission information recommender 3400, and the information poster 3500 may be operated by hardware.

At least some of the event information receiver 3100, the additional information receiver 3200, the service recommender 3300, the transmission information recommender 3400, and the information poster 3500 may be included in the controller 3800. The event information receiver 3100, the additional information receiver 3200, the service recommender 3300, the transmission information recommender 3400, the information poster 3500, and the controller 3800 may be operated by one processor, but are not limited thereto.

Certain aspects of the present disclosure may be embodied as computer readable code on a non-transitory computer-readable recording medium that includes a computer-executable command, such as a computer-executable program module. The non-transitory computer-readable recording medium may be a usable medium that may be accessed by a computer and may include all of a volatile medium and a non-volatile medium and a separable and inseparable medium. The non-transitory computer-readable recording medium may also include all of a computer storage medium and a communication medium. The computer storage medium may include all of volatile and nonvolatile mediums and separable and inseparable mediums that store information, such as a computer-readable command, a data structure, a program module, or other types of data, through an arbitrary method or technique. The communication medium may include a computer-readable command, a data structure, a program module, other types of data of a transformed data signal, or other transmission mechanisms, or an arbitrary information transmission medium.

A non-transitory computer readable recording medium is any data storage device that can store data which can be thereafter read by a computer system. Examples of the non-transitory computer readable recording medium include Read-Only Memory (ROM), Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of transmitting information related to an event, the method comprising:
acquiring, by an event information acquirer, event information related to the event that occurs due to a connection of a device to a counterpart device through a Wireless Personal Area Network (WPAN);
acquiring, by an additional information acquirer, additional information related to the event;
displaying, by a service list display unit, a list of services corresponding to a type of the event based on the event information and the additional information;
selecting at least one service from the displayed list of services based on a user input; and
transmitting the event information and the additional information to a server that provides the selected service.

2. The method of claim 1, further comprising:
storing a use history of the selected service,
wherein the displaying of the list of services comprises recommending the list of services to be displayed based on the event information, the additional information, and the service use history.

3. The method of claim 1, further comprising:
providing an edit window for editing the event information and the additional information; and
editing the event information and the additional information based on a user input performed through the edit window,
wherein the edited event information and the edited additional information are transmitted to the server that provides the selected service.

4. The method of claim 1, further comprising:
storing transmission history of the event information and the additional information according to the selected service; and
recommending portions of the event information and the additional information based on the stored transmission history,
wherein the recommended event information and the recommended additional information are transmitted to the server that provides the selected service.

5. The method of claim 1, wherein the event information and the additional information are converted into formats that are usable in the selected service, and wherein the converted event information and the converted additional information are transmitted to the server.

6. The method of claim 1, wherein the event comprises at least one of a payment event, a business card exchange event, a content exchange event, and a public transportation fare payment event, and wherein the event information comprises at least one of an article name, a shop name, a payment amount, business card information, a content type, a content title, and transportation information.

7. The method of claim 1, wherein the additional information comprises at least one of a date, a time, and a place when the event occurs, an image captured by the device within a preset time period from the time when the event occurs, an image captured by the device within a preset distance from the place where the event occurs, a voice recorded by the device within a preset time period from the time when the event occurs, and a voice recorded by the device within a preset distance from the place where the event occurs.

8. The method of claim 1, wherein the service comprises a Social Network Service (SNS), wherein one service is selected from the list of services, and wherein an application corresponding to the selected service is executed.

9. The method of claim 1, wherein the selected service comprises a diary providing service, and wherein a position in which the event information and the additional information are to be recorded is determined in a diary of a user provided by the service based on a date when the event occurs.

10. A device comprising:
an event information acquirer configured to acquire event information related to an event that occurs due to a connection of the device to a counterpart device through a Wireless Personal Area Network (WPAN);
an additional information acquirer configured to acquire additional information related to the event; and
a service list display unit configured to display a list of services corresponding to a type of the event based on the event information and the additional information,
wherein at least one service is selected from the displayed list of services based on a user input, and wherein the event information and the additional information are transmitted to a server that provides the selected service.

11. The device of claim 10, wherein the service list display unit recommends a list of services to be displayed based on use history of the event information, the additional information, and the selected service.

12. The device of claim 10, further comprising:
a transmission information determiner configured to determine information that is to be transmitted to the server among the event information and the additional information,
wherein the transmission information determiner provides an edit window for editing the event information and the additional information, edits the event information and the additional information based on a user input performed through the edit window, and transmits the edited event information and the edited additional information to the server.

13. The device of claim 12, wherein the transmission information determiner recommends portions of the event information and the additional information based on transmission history of the event information and the additional information,
wherein the recommended event information and the recommended additional information are transmitted to the server that provides the selected service.

14. The device of claim 10, wherein the event information and the additional information are converted into formats that are usable in the selected service, and wherein the converted event information and the converted additional information are transmitted to the server.

15. The device of claim 10, wherein the event comprises at least one of a payment event, a business card exchange event, a content exchange event, and a public transportation fare payment event, and wherein the event information comprises at least one of an article name, a shop name, a payment amount, business card information, a content type, a content title, and transportation information.

16. The device of claim 10, wherein the additional information comprises at least one of a date, a time, and a place when the event occurs, an image captured by the device within a preset time period from the time when the event occurs, an image captured by the device within a preset distance from the place where the event occurs, a voice recorded by the device within a preset time period from the time when the event occurs, and a voice recorded by the device within a preset distance from the place where the event occurs.

17. The device of claim 10, wherein the service comprises an SNS, and wherein an application corresponding to the selected service is executed as one service is selected from the list of services.

18. The device of claim 10, wherein the service comprises a diary providing service, and wherein a position where the event information and the additional information are to be recorded is determined in a diary of a user provided by the selected service based on a date when the event occurs.

19. A method of providing recommendation information for transmitting event information through a server, the method comprising:
receiving the event information related to an event that occurs due to a connection of a device to a counterpart device through a Wireless Personal Area Network (WPAN), from the device;
receiving additional information related to the event from the device;
recommending a service, which is used by the device to transmit the event information and the additional information, to the device based on the event information and the additional information; and
recommending portions of the event information and the additional information to the device, so that the portions of the event information and the additional information are transmitted through the service,
wherein at least portions of the event information and the additional information are transmitted from the device through a service selected from among the recommended services.

20. A method of transmitting information related to an event, the method comprising:
acquiring event information related to the event that occurs due to a connection of a device to a counterpart device through a Wireless Personal Area Network (WPAN);
acquiring additional information related to the event;
recommending at least portions of the event information and the additional information as information that is to be transmitted through a diary service based on a transmission history of information transmitted through the diary service; and
transmitting the recommended event information and the recommended additional information to a server that provides the diary service.

21. A non-transitory computer-readable recording medium having recorded thereon a program, which, when executed by a computer, implements the method of claim 1.

22. A non-transitory computer-readable recording medium having recorded thereon a program, which, when executed by a computer, implements the method of claim 19.

23. A non-transitory computer-readable recording medium having recorded thereon a program, which, when executed by a computer, implements the method of claim 20.
